(19) United States
(12) Patent Application Publication
(10) Pub. No.: US 2011/0119195 A1
(43) Pub. Date: May 19, 2011

(54) DEFINING INFRASTRUCTURE DESIGN IN A TECHNICAL PROJECT MANAGEMENT SYSTEM

(75) Inventors: James Kevin McLees, Richmond, VA (US); Kellie Michele Smirnoff, Jacksonville, FL (US); Shantele LaTrece Stills, Jacksonville, FL (US); Peter Babb, Charlotte, NC (US); Thomas Holleman, Highland Park, IL (US); Matthew W. Moyer, North Riverside, IL (US)

(73) Assignee: BANK OF AMERICA CORPORATION, Charlotte, NC (US)

(21) Appl. No.: 12/852,997

(22) Filed: Aug. 9, 2010

Related U.S. Application Data
(63) Continuation-in-part of application No. 12/618,238, filed on Nov. 13, 2009.

(51) Int. Cl. G06Q 10/00

(52) U.S. Cl. 705/301

(57) ABSTRACT

Systems, methods, and computer program products are defined that provide for managing a technical project and in particular the infrastructure design phase of the technical project. Specifically, embodiments provide for an end-to-end project delivery tool that includes defining the infrastructure design requirements of the technical project. The technical project management delivery tool herein described automates the capture of data and other functionality, such as identification of design infrastructure and the like, to add increased efficiency as it relates to the design and build phases of a technical project.

### CROSS-REFERENCE TO RELATED APPLICATION

This application is a continuation-in-part of co-pending patent application Ser. No. 12/618,238, filed Nov. 13, 2009, entitled “Technical Project Management System”, assigned to the same inventive entity; the entire disclosure of which is incorporated herein by reference.

### FIELD

In general, embodiments herein disclosed relate to systems, methods, and computer program products for technical project management and, more specifically, a defining the infrastructure design within a comprehensive system for managing the delivery of a technical project.

### BACKGROUND

Many projects undertaken by large corporations, such as computer network infrastructure design projects and the like, involve a myriad of tasks that need to be completed in order to see the project through from the planning stage to the build/implementation phase and subsequent approval and reporting. Many of these tasks are manual and otherwise time-consuming. These various tasks include, but are not limited to, drafting and cataloging technical requirements; validation of business requirements and translation of business requirements into technical requirements; collaboration with business partners to understand project dependencies; disposition of individual business and technical requirements, and analysis of custom, standard and/or existing capacity needed to fulfill requirements. Additionally, once initial documentation, such as technical requirement documentation is validated and approved, the documents are baselined and risks are identified and documented. Finally, resource availability is determined to perform the necessary design functions and tasks are consolidated when applicable.

In particular, in many projects, business and technical requirements are often defined manually and the associated risks and constraints are identified manually. Such a manual process allows for variances in the quality of the output and increases the design completion time. These variances in quality may be due to lack of technical resources, lack of access to existing documentation, lack of availability of third party/client resources, inexperience of design team associates and the like.

Additionally, in most project management systems, tracking of data is minimal or not performed at all. As such traceability, in terms of business requirements, technical requirements, technical constraints and the like, is lacking. In addition, in failing to track and/or store relevant data associated with a project, all downstream projects must be re-engineered and are incapable of leveraging off information learned from previous projects.

Therefore, a need exists to develop methods, systems, computer program products and the like which provide for a comprehensive project management system that includes infrastructure design. A need exists to develop a system that adds project consistency to project infrastructure design. In addition, the desired project management system should consolidate, gather and store all design inputs, such that, subsequent projects can leverage off design gathered and learned during previous projects. In particular, the desired system should allow for infrastructure design to be identified based on previously completed infrastructure designs associated with the same business requirements seen in the current project. Additionally, the desired system should automate other aspects of the project, such as requisition decisioning and the like. The result of the desired system may include, but is not limited to, a reduction in design completion time, enterprise and global consistency of project output and the like.

### SUMMARY

The following presents a brief summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Methods, systems and computer program products are defined that provide for technical project management and specifically infrastructure design management. Specifically, the technical project management embodiments provide a consolidated end-to-end project delivery tool that serves to add efficiency and consistency to the design processes of a technical project, such as an information technology project or the like. The system herein described reduces the complexity in the design processes and improves hand-off between the phases of the project. Additionally, through the re-use and reliance on existing designs, speed of design and quality of design is improved. Further embodiments of the invention, provide for measuring relevant metrics and identifying areas for process improvement.

A method for technical project management defines first embodiments of the invention. The method includes receiving, via a technical requirements application, first user inputs that define a plurality of high-level design elements and design requirements for a technical project and storing, in a technical project database, the high-level design elements and design requirements. The method further includes automatically, pre-populating, via a computing device processor, first predefined input fields within an infrastructure design application with the high-level design elements and requirements. Additionally, the method includes automatically, presenting, via a computing device processor, design element tiers and design requirement sections within the infrastructure design application that correspond to the design elements and design requirements.

In specific embodiments the method further includes receiving, via the infrastructure design application, second user inputs at a first design element tier that define specific infrastructure design element criteria. In such embodiments, the method may further include automatically, pre-populating, via a computing device processor, second predefined input fields within the first design element tier. The second predefined input fields are pre-populated with the specific infrastructure design element criteria. In other such embodiments, the method may include automatically, pre-populating, via a computing device processor, third predefined input fields within one or more design requirement sections. The third predefined input fields are pre-populated with the specific infrastructure design element criteria.

In still further specific embodiments the method includes receiving, via the infrastructure design application, second user inputs at a first design requirement section that define specific infrastructure design requirement criteria. In such embodiments, the method may include automatically, pre-populating, via a computing device processor, second predefined input fields within the first design requirement section. The second predefined input fields are pre-populated with the specific infrastructure design requirement criteria.

In yet other specific embodiments the method includes automatically, pre-populating, via a computing device processor, second predefined input fields with the infrastructure design application, wherein the second predefined input fields are pre-populated with project contact information.

Additionally, other specific embodiments of the method include automatically generating and initiating electronic communication, via a computing device processor, of an infrastructure design notification to predetermined build team contacts based on completion of one or more portions of the infrastructure design application. In such embodiments of the method the infrastructure design notification may include a link to an output of the infrastructure design application.

In other specific embodiments the method includes receiving, at a computing device, second user inputs that define infrastructure design reporting criteria. In such embodiments the method may include generating and initiating electronic communication, via computing device processor, of an infrastructure design report to predetermined build team contacts based on completion of one or more portions of the infrastructure design application. The infrastructure design report includes information specified by the infrastructure design reporting criteria.

In still further specific embodiments the method includes automatically presenting, via a computing device processor, access to one or more design infrastructure diagrams in the infrastructure design application, wherein the design infrastructure diagrams are associated with the current technical project or a previous related technical project.

A system for technical project management provides second embodiments of the invention. The system includes at least one computing device including at least one processor and a memory. The system further includes a technical project management system stored in the memory and executable by the at least one processor. The technical project management system includes a project database configured to store technical project records. Additionally, the technical project management system includes a technical requirement module including a technical requirements application configured to receive first user inputs that define a plurality of high-level design elements and design requirements for a technical project and configured to store the high-level design elements and design requirements in the project database. In addition, the technical project management system includes an infrastructure design module including an infrastructure design application configured to automatically pre-populate first predefined input fields n with the high-level design elements and requirements and automatically, present design element tiers and design requirement sections that correspond to the design elements and design requirements.

In specific embodiments of the system the infrastructure design application is further configured to receive second user inputs at a first design element tier that define specific infrastructure design element criteria. In such embodiments of the system, the infrastructure design application may be further configured to automatically, pre-populate second predefined input fields within the first design element tier. The second predefined input fields are pre-populated with the specific infrastructure design element criteria. In other such embodiments of the system, the infrastructure design application is further configured to automatically, pre-populate third predefined input fields within one or more design requirement sections. The third predefined input fields are pre-populated with the specific infrastructure design element criteria.

In additional specific embodiments of the system, the infrastructure design application is further configured to receive second user inputs at a first design requirement section that define specific infrastructure design requirement criteria. In such embodiments of the system, the infrastructure design application is further configured to automatically, pre-populate second predefined input fields within the first design requirement section. The second predefined input fields are pre-populated with the specific infrastructure design requirement criteria.

In other specific embodiments of the system, the infrastructure design application is further configured to automatically, pre-populate second predefined input fields. The second predefined input fields are pre-populated with project contact information stored in the project database.

In still further specific embodiments of the system, the infrastructure design module further comprises a build team notification application configured to automatically generate and initiate electronic communication of an infrastructure design notification to predetermined build team contacts based on completion of one or more portions of the infrastructure design application. In such embodiments, the infrastructure design notification includes a link to an output of the infrastructure design application.

In yet other specific embodiments of the system, the infrastructure design module further comprises a build team reporting application configured to receive second user inputs that define infrastructure design reporting criteria. In such embodiments, build team reporting application may be further configured to generate and initiate electronic communication of an infrastructure design report to predetermined build team contacts based on completion of one or more portions of the infrastructure design application. The infrastructure design report includes information specified by the infrastructure design reporting criteria.

In additional specific embodiments of the system, the infrastructure design application is further configured to automatically present access to one or more design infrastructure diagrams in the infrastructure design application, wherein the design infrastructure diagrams are associated with one of the current project or a previous related technical project.

A computer program product that includes a non-transitory computer-readable-medium defines third embodiments of the invention. The computer-readable medium includes a first set of codes for causing a computer to receive, via a technical requirements application, first user inputs that define a plurality of high-level design elements and design requirements for a technical project. Additionally, the computer-readable medium includes a second set of codes for causing a computer to store, in a technical project database, the high-level design elements and design requirements. Additionally, the computer-readable medium includes a third set of codes for causing a computer to automatically, pre-populate, first predefined input fields within an infrastructure design application with the high-level design elements and requirements. The computer-readable medium includes a fourth set of codes for causing a computer to automatically, present design element tiers and design requirement sections within the infrastructure design application that correspond to the design elements and design requirements.

Thus, as described in more detail below, systems, methods, computer programs and the like are defined that provide for managing a technical project and, specifically the infrastructure design of a technical project. In particular, embodiments provide for an end-to-end project delivery tool that includes infrastructure design and approving and providing communication/reporting of the technical project. The technical project management delivery tool herein described automates the capture of data and other functionality, such as identification of infrastructure design and the like, to add increased efficiency as it relates to the design phases of a technical project. Further, embodiments herein described consolidate all design inputs into a central data store and automate the flow of this data throughout the infrastructure design phase.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram of a system for technical project management, in accordance with an embodiment of the present invention;

FIG. 2 is a flow diagram of a method for technical project management, in accordance with embodiments of the present invention;

FIG. 3 is a block diagram of an infrastructure design module within a technical project management system, in accordance with present embodiments;

FIG. 4 is a flow diagram of a method for infrastructure design management in a technical project management system, in accordance with present embodiments; and

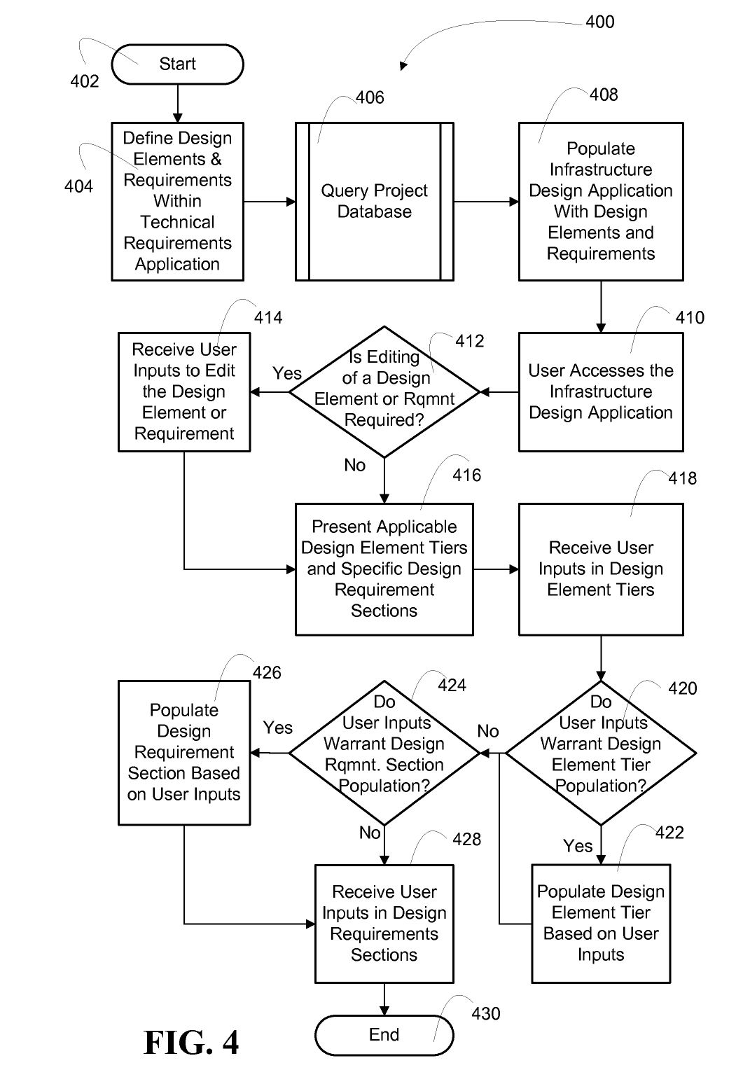

FIG. 5 is a detailed block diagram of an infrastructure design module and application in a technical project management system, in accordance with present embodiments.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Present embodiments provide for systems, methods, computer program products and the like for managing a technical project. In particular, embodiments of the invention provide for an end-to-end project delivery tool that includes planning, defining the requirements, designing, building, approving and providing communication/reporting of the technical project. The technical project management delivery tool herein described automates the capture of data and other functionality, such as identification of technical requirements and the like, to add increased efficiency as it relates to the design and build phases of a technical project. In addition, the project management delivery tool herein described improves hand-offs and communication amongst disparate entities of a technical project.

In addition, by providing for the capture of data at all phases of the technical project, present embodiments of the invention, improve overall project delivery speed and quality through the re-use of data, such as the re-use of designs and the like. In this regard, the technical project management system herein described consolidates the planning, design and build inputs of a technical project into a central data store and automates the flow of such data throughout the planning, technical requirements, infrastructure design, build and/or configuration phases of the project. Such centralized data storing provides the ability to replicate previously completed technical requirements and infrastructure design; eliminating the need to recreate such data each time a similar project request is made.

Moreover, present embodiments provide for measurement of relevant metrics throughout the project delivery process and identification of areas requiring process improvement.

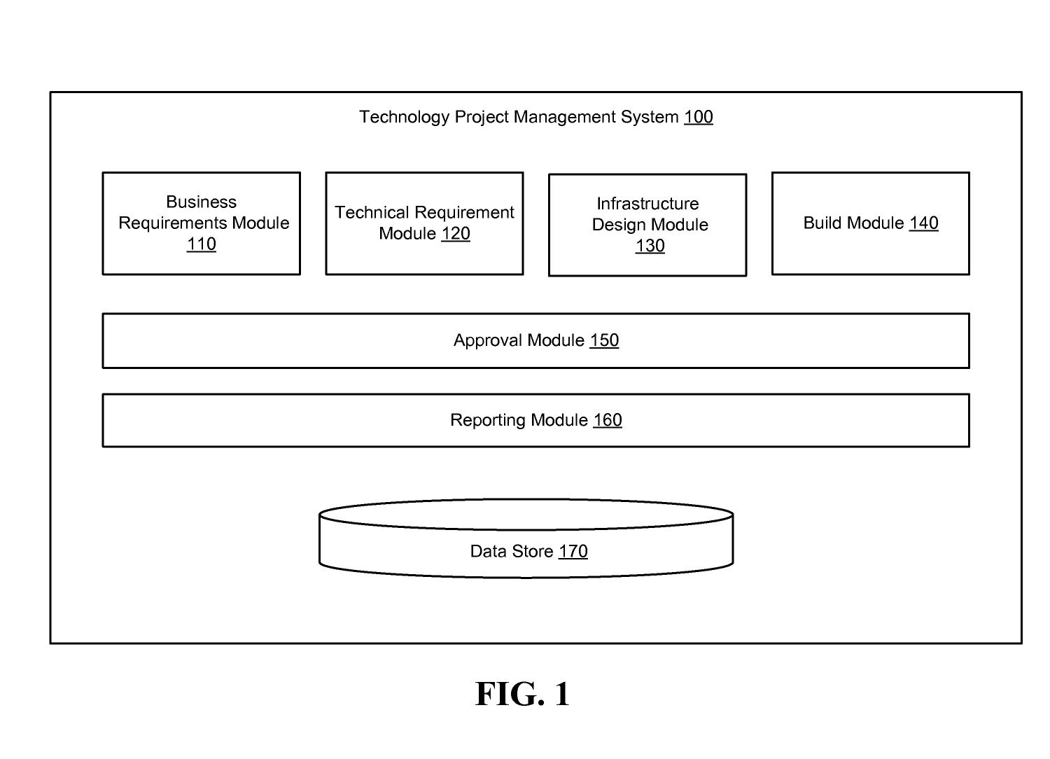

Referring to FIG. 1, a block diagram is depicted of a technology project management system 100. The technology project management system 100 includes a plurality of modules that serve to automate and streamline the overall technology project management process. It should be noted that the modules shown in FIG. 1 are by way of example only and, as such, embodiments of the present invention may include one or more or the modules shown and/or additional modules. As shown, the technology project management system 100 includes business requirements module 110, technical requirements module 120, infrastructure design module 130, build module 140, approval module 150, reporting module 160 and centralized data store 170.

Business requirements module 110 provides for identification and capture of business requirements. In addition, business requirements module 110 provides for initial planning of a technical project, such as identification and capture of the general information related to the technical project and/or identification and assessment of the technology impact of the project.

Technical requirements module 120 provides for identification and capture of technical requirements and, more specifically, the technical requirements that satisfy identified business requirements. In one embodiment of the invention, the user of the technical requirements module 120 defines and associates one or more technical requirements with a previously identified business requirement. In other embodiments of the invention, technical requirements are identified by mapping the identified technical project business requirements to one or more technical requirements and allowing for selection of the technical requirements based on the mapping and/or input of technical requirements not otherwise related to business requirements. In addition, the technical requirements module 120 provides for validating the technical requirements.

Additionally, the technical requirements module 120 provides for identification and capture of project administration data, such as design elements, project contacts and sign-off, infrastructure dependencies, and technical project overview information, such as project assumptions, project risks and/or project constraints. Moreover, the technical requirement module provides for assessing and capturing application, hardware, storage, data retention, high-availability, security, encryption, authentication, operations, facilities, business volume, interface voice and throughput requirements and the like.

Infrastructure design module 130 provides for identifying the design objectives for the technical project and the high level and low level infrastructure/design requirements necessary to build or otherwise implement the technical project. The design requirements serve to identify the data elements, physical or otherwise, subsequently required by the build entity/team. In this regard, the infrastructure design module 130 receives the technical requirements outputted by the technology requirements module 120 and maps or otherwise identifies the design requirements based on the technical requirements. Further, the infrastructure design module 130 serves to validate technical project design solutions. In addition, the infrastructure design module 130 identifies individuals, teams/entities or the like involved in the build phase of the technical project, including third party entities, such as external vendors, suppliers or the like.

Build module 140 provides for automation of the build process by identifying the types of builds that can be automated and implementing automated builds based on the infrastructure/design requirements identified by infrastructure design module 130. In addition to creating and capturing an identified build process, the build module 140 tracks completion of the build by registering completion of build processes in the centralized data store 170. In addition, the tracking function of build module 140 insures or otherwise monitors scheduling requirements to insure that the technical project remains on schedule. Thus, proper automated alerts and/or automated notifications may be implemented to insure that build processes occur on schedule and the like. In this regard, the build module 140 may provide for monitoring and managing of external vendors and/or suppliers to insure that external procurements and/or services are delivered as scheduled and the like.

Approval module 150 provides for utilization of workflow capabilities to insure documentation is properly reviewed and approved by designated entities, processes are properly queued and the like. The documentation may include, but is not necessarily limited to, business requirement documentation, technical requirement documentation, design documentation, build documentation and the like. In this regard approval module 150 provides for approval of various steps, processes and the like associated with the business requirements module 110, the technical requirements module 120, the infrastructure design module 130 and/or the build module 140. The approval module streamlines the communication of documentation to the designated individuals and/or parties to further heighten efficiency in the overall technical project management scheme.

Reporting module 160 provides for automatically capturing predetermined technical project management metrics, such as on-time metrics, quality metrics and the like. In this regard reporting module 160 provides for capturing technical project management metrics from the business requirements module 110, the technical requirements module 120, the infrastructure design module 130 and/or the build module 140. In addition to capturing the metrics, reporting module 160 provides for automatically generating and communicating metrics related reports to designated individuals and/or parties/entities.

Centralized data store 170 provides for a project record database. Each technical project has an associated project record that includes all the information determined and collected at the various modules. In this regard, the project record may include, but is not limited to, business requirements, project risks, project assumptions, project constraints, technical requirements, project approval designations, infrastructure design, build/workflow plans, project performance metrics, project performance reports, and the like. The historical aspect of the project records allows for subsequent technical projects to leverage off of previous project records as a basis for determining courses of action. As such, technical requirements, infrastructure design, build plans, and the like can be determined for a present technical project based on previously learned experiences of a previous project.

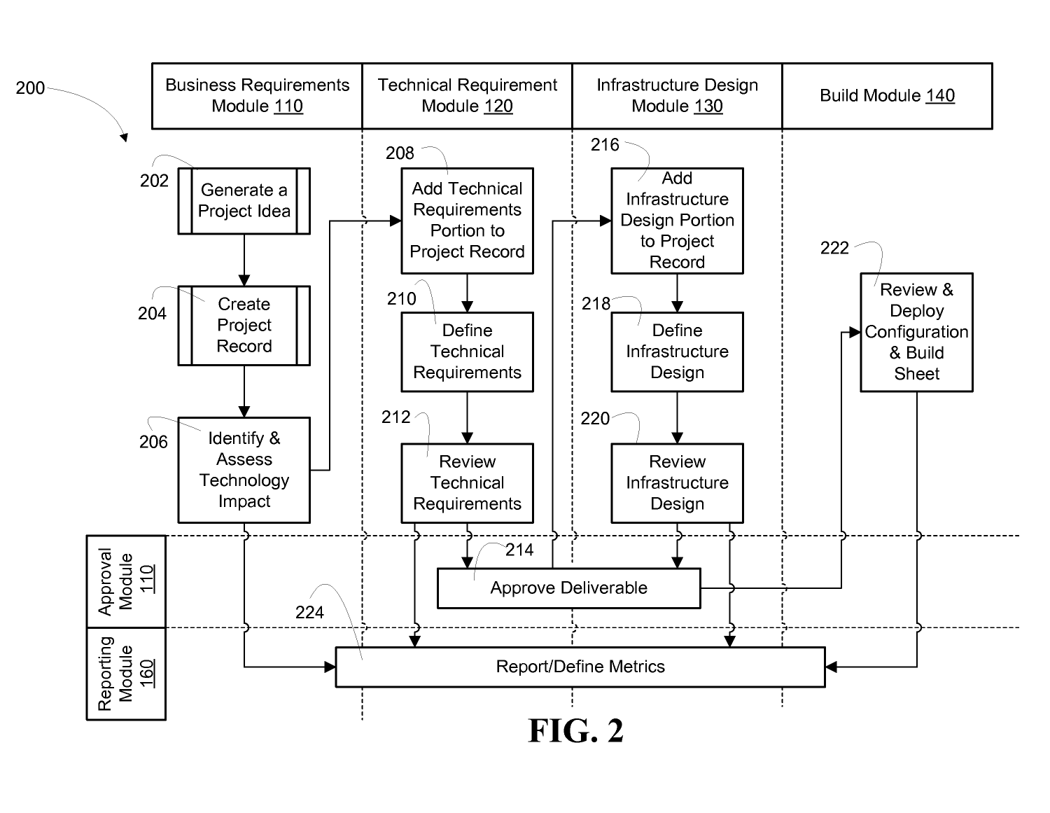

Referring to FIG. 2, a flow diagram is presented of a method 200 for technical project management implementing the modules shown in FIG. 1, in accordance with an embodiment of the invention. At Event 202, a technical project idea is generated by an appropriate project stakeholder. The technical project is defined by requiring the implementation of technical resources, such as new infrastructure, modifications to existing infrastructure, computer network and the like. In one embodiment of the method, the project idea may be captured by the business requirements module 110 of technical project management system 100. At Event 204, the project is originated by creation of a project record within the business requirements module 110. The record is subsequently stored in the central data store and used in various different phases/modules of the technical project management process. The project record defines project information, such as project name, requester/stakeholder name, project sponsor, sponsor hierarchy, project priority, and the like. At Event 206, the technology impact of the project is identified and assessed. The technology impact aids in identifying the business requirements and/or technology requirements associated with the technical project.

At Event 208, a technical requirements portion is added to the project record within the technical requirements module 120. In one embodiment of the invention, the requirements are captured by an information-gathering application configured to create and deploy electronic form solutions to gather information off-line, efficiently and reliably. In other embodiments of the invention, the technical requirements may be captured by a Graphical User Interface (GUI) application configured to provide online or network access to the technical requirement portion of the project record.

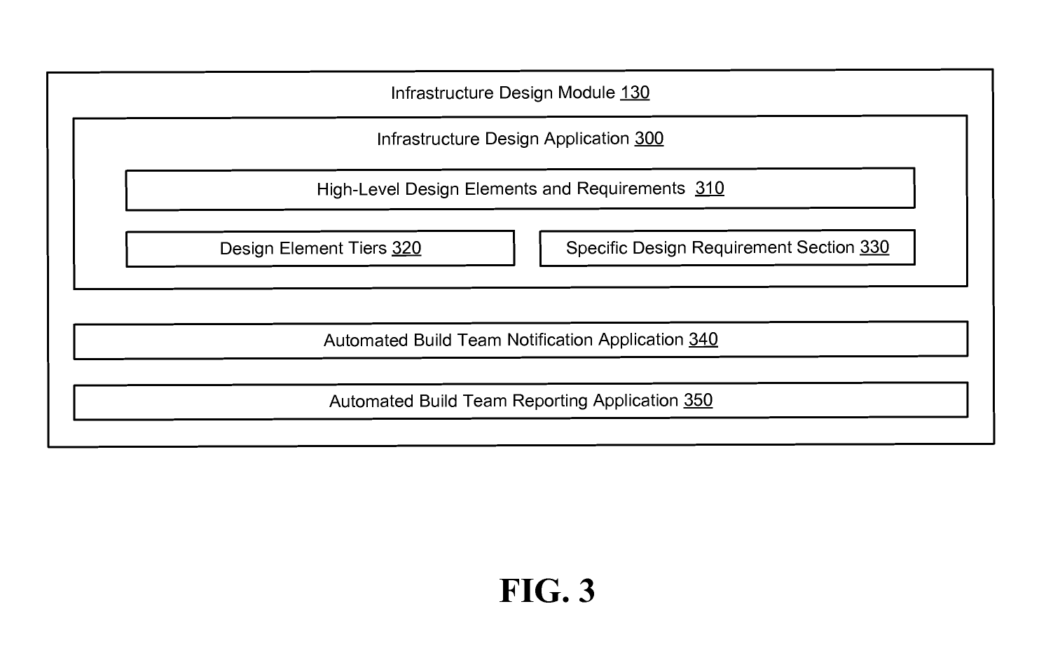

As such, at Event 210, technical requirements are defined and captured within the requirements portion of the project record. As described in relation to FIG. 3 and in accordance with specific embodiments, the technical requirement module 120 may be configured to provide a mapping of identified business requirements to one or more technical requirements. In those embodiments in which the mapping provides for mapping a business requirement to a plurality of technical requirements, a user, such as a design team administrator or the like, may select which of the mapped technical requirements are applicable to the present technical project. Additionally, in other specific embodiments, technical requirements may be inputted by the user, such as, for example, in the event that the technical requirement module 120 provides for a user to define the technical requirement(s) based on the predefined business requirement or the technical requirement is not currently mapped to a business requirement.

In addition to identifying and capturing technical requirements, the technical requirement portion of the project record provides for identifying and capturing application, hardware, storage, data retention, high-availability, security, encryption, authentication, operations, facilities, business volume, interface voice and throughput requirements and the like.

At Event 212, a requirements review is conducted by a designated party/entity, such as an infrastructure/build team or the like, to ensure the accuracy and completeness of the technical requirement portion of the project record.

At Event 214, the technical requirements are approved by designated individuals and/or entities. In addition, any other deliverables identified at the technical requirement module that require approval, are approved at this stage. In specific embodiments of the invention, approval of a deliverable is a pre-requisite of initiating a further deliverable. For example, the technical requirements may require approval prior to initiating design requirement identification and the like. In addition, an approval may be required within the technical requirements module prior to initiating another deliverable within the technical requirements module.

At Event 216, the infrastructure design requirements portion is added to the project record within the infrastructure design module 130. In one embodiment of the invention, the infrastructure design requirements are captured by an information-gathering application configured to create and deploy electronic form solutions to gather information off-line, efficiently and reliably. In other embodiments of the invention, the infrastructure design requirements may be captured by a Graphical User Interface (GUI) application configured to provide online or network access to the infrastructure design requirement portion of the project record.

At Event 218, infrastructure design is defined and captured within the infrastructure design portion of the project record. As previously discussed, according to specific embodiments, the technical project system provides for mapping the technical requirements to one or more deign requirements. The infrastructure design requirements identify the requirements to build the technical project, including the data elements required by the build team. In addition to identifying design requirements, costs and funding associated with the design requirements may be defined and/or identified. In addition to defining infrastructure design, at this stage of the process, data elements may be procured, both internally and externally from vendors/suppliers. The data elements may include physical elements, such as hardware or the like, intellectual elements, such as software or the like and/or services.

At Event 220, an infrastructure design review is conducted by a designated party/entity, such as an infrastructure/build team or the like, to ensure the accuracy and completeness of the infrastructure design portion of the project record.

At Event 214, the infrastructure design is approved by designated individuals and/or entities. In addition, any other deliverables identified at the infrastructure design module that require approval, are approved at this stage. In specific embodiments of the invention, approval of a deliverable is a pre-requisite of initiating a further deliverable. For example, the infrastructure design may require approval prior to initiating review and deployment of the build and the like. In addition, an approval may be required within the infrastructure design module prior to initiating another deliverable within the infrastructure design module.

At Event 222, a configuration and build sheet is reviewed and deployed that defines the build requirements for the technical project. As previously discussed, the build module 140 may define build requirements/build sheets based on the design requirements and the like. Deployment of the build sheet provides for initiation, implementation and completion of the technical project.

At Event 224, technical project management metrics are determined and/or collected from the various modules that include reporting metrics or information related to reporting metrics. In one specific embodiment, the technical project management metrics are collected from the technical requirement 110 and infrastructure design 120 modules. However, in other embodiments technical project management metrics may be collected from the business requirement module 100 and/or the build module 140, as well. In addition, as previously noted the reporting module 160 is configured to generate reports based on the reporting metrics and communicate the reports to predetermined entities, such as management teams or the like.

Turning the reader's attention to FIG. 3 a block diagram is presented of the infrastructure design module 130 within a technical project management system, in accordance with embodiments of the present invention. The infrastructure design module 130 includes an infrastructure design application 300. From a data input standpoint, the infrastructure design application 300 may take the form of an information-gathering application, such as InfoPath®, available from Microsoft Corporation of Redmond, Wash. or the like. In such an application, the user is able to download or otherwise obtain the necessary infrastructure design documentation, provide inputs to the document and upload the document to the central data store. In this regard, the information-gathering application provides for off-line utilization. From a data output standpoint, the infrastructure design application 300 may take the form of a spreadsheet application, such as Excel®, available from Microsoft Corporation of Redmond, Wash. or the like.

The infrastructure design application 400 includes high-level design and elements and requirements 310 that define the high-level design elements and requirements required for the project. High-level design elements and requirements may include, but are not limited to, web/presentation servers; applications; database; integration; reporting; documentation management; hardware storage; network and facilities; operations and monitoring; infrastructure capacity; hosting and operations support; and the like.

In specific embodiments of the invention, the high-level design elements and requirements 310 are identified previously via the technical requirements module 120 (shown in FIG. 1) and imported into the infrastructure design application 300. In other specific embodiments of the invention, the high-level design elements and requirements 310 are based on a technical requirement-to-design element/requirement mapping. Technical requirements, defined in the technical requirements module 120 are mapped to specific high-level design elements and/or requirements, such that identifying one or more technical requirements within the technical requirements module 120 provides for the corresponding high-level mapped design element and/or requirement to be present in the infrastructure design application 300. The user/design team associate may alter (i.e., delete or add) the high-level design elements and requirements, as project need requires.

Each of the high-level design elements and requirements are associated with a design element tier 320 or specific design requirement section 330. Such that, presence of a high-level design element or requirement 310 in the application 300, provides for presentation of the corresponding design element tier 320 or specific design requirement section 330. In this regard, if a high-level design element or requirement is not required for the project at hand, the corresponding design element tier 320 or specific design requirement section 330 is not presented in the application or otherwise collapsed or hidden. As such, the user/design team associate is presented with a concise application that only requires inputs for design elements or requirements relevant to that specific project.

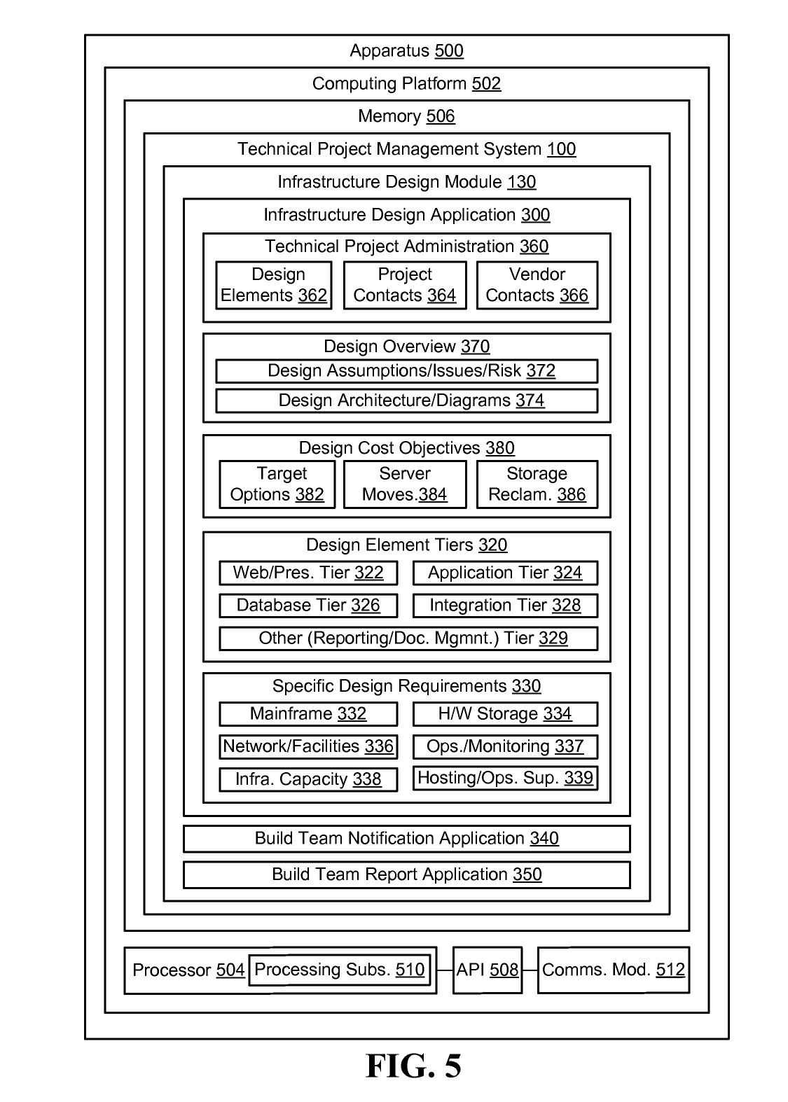

As described in more detail in relation to FIG. 5, infra. in accordance with specific embodiments, the design element tiers 320 may include, but are not limited to, web/presentation servers tier; applications tier; database tier; integration tier; other tier (including reporting and documentation management) and the like. Moreover, the specific design requirement sections 330 may include, but are not limited to, hardware storage; network and facilities; operations and monitoring; infrastructure capacity; hosting and operations support; and the like.

Design element tiers 320 provide for user input of data related to design elements within the specific tier. In addition, design element tiers 320 are configured such that repetitive information inputted in a high level sub-tier is pre-populated in lower level sub-tiers so as to limit the data input requirements. Specific design requirement sections 330 provide for user input of data related to specific design requirements. In addition, specific design requirements 330 are configured to be pre-populated with repetitive data from the design element tiers 320. Moreover, specific design requirement section 330 are configured such that repetitive information inputted in a high level sub-section is pre-populated in lower level sub-sections so as to limit the data input requirements.

Additionally, the infrastructure design module 130 may optionally include automated build team communication application 340 that is configured to automatically generate and communicate build instructions to predetermined build contacts. For example, in specific embodiments, emails, or some other form of electronic communication, may be automatically generated upon user activation of a build team communication mechanism or completion of the infrastructure design application 300 and, once generated, communicated to the predetermined build team associates. The emails may be configured to include a link to the applicable design element tiers 320, specific design requirement sections 330 or other portions of the infrastructure design application 300 that are pertinent to that particular build team.

In addition, the infrastructure design module 130 may optionally include automated build team report application 350 that is configured to allow build teams to identify which tiers, sub-tiers, sections, sub-sections or specific information within a tier or section are relevant to the build team and to generate customized build team reports that include the identified information. Such customized reports serve to provide the build team with build team-specific information (i.e., build team specific work orders) that can readily be analyzed by the corresponding build team.

FIG. 5 is a flow diagram of a method 400 for defining infrastructure design within a technical project management system, in accordance with one embodiment of the present invention. The method 400 is typically associated with an infrastructure design application that takes the form of an information gathering application, such as InfoPath® or the like. At Event 402, the method is initiated.

At Event 404, design elements and/or design requirements are defined for a specific project within a technical requirements application of the technical project management system and, subsequently stored in the project database.

At Event 406, the project database is queried to determine which design elements and design requirements and, at Event 408, the infrastructure design application is pre-populated with the design elements and/or design requirements identified at the requirements stage. The infrastructure design application may be populated with the design elements and design requirements, prior to user access of the application or in conjunction with a user accessing the application.

At Event 410, a user accesses an infrastructure design application associated with the specific project. As previously noted, a user may download the infrastructure design application or otherwise be provided with network access to the infrastructure design application.

At Decision 412, a determination is made as to whether editing, including deletion or addition, of design element or requirement is necessary. Editing, deletion or addition of a design element or requirement may be needed based on the specific needs of the technical project. If the determination is made that editing is necessary, at Event 414, user inputs are received to edit the design element(s) and/or design requirement(s).

If the determination is made that no editing of the design elements or design requirements is necessary or after completion of the editing process, at Event 416, applicable design element tiers and specific design requirement sections are presented in the infrastructure design application. Thus, design elements tiers and/or design requirement sections that are not applicable to the project or collapsed or otherwise hidden to condense the information presented to the user.

At Event 418, user inputs to high-level sub-tiers of a design element tier are received and, at Decision 420, a determination is made as to whether the user inputs to the high-level tiers warrant population of entry fields in lower level design element sub-tiers. Population is warranted if the lower level design element sub-tiers include repetitive data entry fields. If the determination is made that the lower level design element sub-tiers do warrant population of entry fields based on the user inputs, at Event 422, the specified entry fields in the lower level design element sub-tiers are populated.

If the determination is made that no population of data entry fields in lower level design element sub-tiers is warranted or after completion of the population, at Decision 424, a determination is made as to whether the user inputs in the design element tiers warrant population of data entry fields in any of the design requirement sections. If the determination is made that the design requirement sections do warrant population of entry fields based on the user inputs, at Event 426, the specified entry fields in the design requirements section(s) are populated.

If the determination is made that no population of data entry fields in the design requirement sections is warranted or after completion of the population, at Event 428, user inputs are received in the outstanding data entry fields of the design requirements section. Once all of the necessary fields in the design element tiers and design requirement sections have had date entered or populated the process is completed, as designated by Event 430.

Referring to FIG. 5, shown is a detailed block diagram of apparatus 500, according to embodiments of the present invention. The apparatus 500 is configured to provide a comprehensive technical project management system and, specifically infrastructure design management; in accordance with embodiments of the present invention. In addition to providing detail, FIG. 5 highlights various alternate embodiments of the invention. The apparatus 500 may include one or more of any type of computing device. The present apparatus and methods can accordingly be performed on any form of one or more computing devices.

The apparatus 500 includes computing platform 502 that can receive and execute algorithms, such as routines, modules and applications. Computing platform 502 includes memory 506, which may comprise volatile and non-volatile memory, such as read-only and/or random-access memory (RAM and ROM), EPROM, EEPROM, flash cards, or any memory common to computer platforms. Further, memory 506 may include one or more flash memory cells, or may be any secondary or tertiary storage device, such as magnetic media, optical media, tape, or soft or hard disk.

Further, computing platform 502 also includes processor 504, which may be an application-specific integrated circuit (“ASIC”), or other chipset, processor, logic circuit, or other data processing device. Processor 504 or other processor such as ASIC may execute an application programming interface (“API”) 508 that interfaces with any resident programs, such as infrastructure design application 300, automated build team communication application 340, automated build team reporting application 350 and algorithms associated therewith or the like stored in the memory 506 of the apparatus 500.

Processor 504 includes various processing subsystems 510 embodied in hardware, firmware, software, and combinations thereof, that enable the functionality of apparatus 500 and the operability of the apparatus on a network. For example, processing subsystems 510 allow for initiating and maintaining communications and exchanging data with other networked devices. For the disclosed aspects, processing subsystems 510 of processor 504 may include any subsystem used in conjunction with infrastructure design application 300, automated build team communication application 340, automated build team reporting application 350 and related algorithms, sub-algorithms, sub-modules thereof.

Computer platform 502 additionally includes communications module 512 embodied in hardware, firmware, software, and combinations thereof, that enables communications among the various components of the apparatus 500, as well as between the other networked devices. Thus, communication module 512 may include the requisite hardware, firmware, software and/or combinations thereof for establishing a network communication connection and communicating build team communications, such as emails or the like or build team reports.

The memory 506 of apparatus 500 stores technical project management system 100 and, specifically, infrastructure design module 130. Infrastructure design module 130 includes infrastructure design application 300 that is configured to define the design requirements for an associated technical project. As previously noted, the input-portion of infrastructure design application 300 may be an information-gathering application or the like, while the output portion of the infrastructure design application 300 may be a spreadsheet application or the like.

The infrastructure design application 300 serves to automate specific actions and tasks associated with identifying infrastructure design. The automation provides integration of pertinent administrative information, design elements, drawings/architectures and the like. The integrated data may come from previously identified technical requirements for the associated project (i.e., the technical requirements module 120 of FIG. 1) or historical records associated with previous projects.

The infrastructure design application 300 may include a project summary section, that includes project-identifying information, a revision history section, and a change control history section and a project administration section. All of which are not depicted in FIG. 5 for the sake of clarity. The project identifying information section includes information that may be auto-populated from a project planning record stored in the centralized data store (170 of FIG. 1) or the information may be inputted or edited by the user/design team associate. The project-identifying information section includes, but is not limited to, project name, project number, project organization, project priority and the like. The revision history section catalogs, summarizes and timestamps changes to the technical requirements document and the revision history section catalogs, summarizes and timestamps edits to the specific technical requirement document.

As an introductory portion, the infrastructure design application 300 includes a technical project administrative section 360 and design overview section 370. The technical project administration section 360 includes an infrastructure design required sub-section (not shown in FIG. 5) that is configured to acknowledge of infrastructure design is required for the project. The application is configured such that selection of the “design not required” field will close or otherwise collapse/hide the entirety of the infrastructure design application 300.

Additionally, technical project administration section 360 includes design element and requirement sub-section 362 that includes design elements and requirements 310 (shown in FIG. 3). As previously noted during discussion of FIG. 3, design elements and requirements 310 define the high-level design elements and requirements required for the project. High-level design elements and requirements may include, but are not limited to, web/presentation servers; applications; database; integration; reporting; documentation management; hardware storage; network and facilities; operations and monitoring; infrastructure capacity; hosting and operations support; and the like. In specific embodiments, the design elements and requirements are identified or mapped during the technical requirements phase of the overall project management system The user/design team associate may alter (i.e., delete or add) the high-level design elements and requirements, as project need requires.

As previously discussed in relation to FIG. 3, if a specific high-level design element or requirement is not required for the project at hand, the corresponding design element tier 320 or specific design requirement section 330 is not presented in the application or otherwise collapsed or hidden. As such, the user/design team associate is presented with a concise application that only requires inputs for design elements or requirements relevant to that specific project. Thus, design element and requirement sub-section 362 may include fields to mark a design element or requirement as “not applicable” and an associated field to input a justification as to why the design element or requirement is not applicable.

The project administration section 360 may additionally include project contact sub-section 364 that is configured to pre-populate project contacts from the project database and/or provide for a user/design team associate to input the contact-related information associated with individuals or entities associated with the technical project. The contact sub-section 364 may link to a corporate directory and or management hierarchy listing for the purpose of identifying the requisite individual or entity responsible for approving a process or stage on the project management scheme. Additionally, project contacts may be pre-populated from the centralized data store, such as the business requirements module 110 (shown in FIG. 1), the technical requirements module 120 (shown in FIG. 1) or the like.

In addition, project administration section 360 may additionally include vendor contacts sub-section 366 that is configured to pre-populate vendor contacts stored in the project database and/or provide for a user/design team associate to input the vendor-related information associated with vendors associated with the technical project. The vendor information may include, but is not limited to, identification of vendors/external sources, including vendor contact, vendor email, vendor telephone numbers and the like.

In addition infrastructure design application 300 includes design overview section 370 that is configured to receive user inputs that define design assumptions, issues and risks and provide access to design architecture. As such, design overview section 370 may include design assumptions, issues, risks sub-section 372 configured to receive user/design team associate inputs that define assumptions, issues and/or risks associated with the design. The input fields in sub-section 372 provide for identifying the type (i.e., assumption, issue or risk), describing the assumption, issue or risk, the date of entry and a confirming individual/entity.

In addition, design overview section 370 may include design diagram/architecture sub-section 374 that provides for manual or automated linking to pre-existing design diagrams/architecture or the like. The pre-existing design diagrams/architecture may be associated with a similar related previous technical project or the pre-existing design diagrams/architecture may be high-level design diagrams associated with the current technical project and stored in the centralized database. As such, design diagram sub-section 374 may provide for a network-accessible link, such as a hyper-link or the like, to diagrams, flow charts, figures or the like.

The infrastructure design application 300 may additionally include design cost objective section 380, otherwise referred to as zero net growth/due diligence section. Design cost objective section 380 provides for identifying standard and/or pre-existing architecture as a means of minimizing costs. Thus, design cost objective section 380 may include target option sub-section 382 configured for receiving user/design team associate inputs that identity a target as standard architecture, existing hardware/equipment or new acquisition. Additionally, design cost objective section 380 may include server decommission/move sub-section 384 that identifies servers to be moved, the location to be moved from and the location to be moved to, as well as, identification of servers to be decommissioned. Additional entry fields in the server moves sub-section 384 provide for identifying server/host name, hardware model, the location the server is moved from and the location the server is moved to. In addition, design cost objective section 380 may include storage reclamation sub-section 386 that identifies servers/storage that can be reclaimed.

The infrastructure design application 300 additionally includes infrastructure design tier section 320. The infrastructure design tier section 320 may include one or more of infrastructure design tiers, such as, but not limited to, web/presentation tier 322, application tier 324, database tier 326, integration tier 338 and other tier 339. The tiers are selected or confirmed at an environment level and selection of a tier logically determines the fields applicable for that tier.

Moreover, the tiers within infrastructure design tier section 320 are configured such that inputted repetitive higher-level sub-tier information is pre-populated into lower-level sub-tiers, as a means of minimizing the amount of information that needs to be manually inputted by the user/design team associate.

The web/presentation tier 322 includes various sub-tiers for identifying design requirements associated with web/presentation requirements. In addition, the web/presentation tier 322 provides for identifying web/presentation requirements in more than one environment, such as development, production, contingency or the like. In specific embodiments, the web/presentation tier 322 includes web server/visualization/networking profile sub-tier configured to receive user inputs for environment, server types, functionality, network type, security/firewall requirements, load balancing requirements, existing devices and the like. In addition web/presentation tier 322 may include application Uniform Resource Locator (URL) sub-tier configured to receive user inputs or pre-populate environments, Domain Name System (DNS) names, URL status, Internet Protocol (IP) address and the like. Additionally, web/presentation tier 322 may include web server platform specification sub-tier configured to receive user inputs or pre-populate information to build out web server platforms, such as server name, server type, hardware model, processing capability, memory requirements, operating system, supporting software, interface cards and the like.

Additionally, web/presentation tier 322 may include visualization/network platform specification sub-tier configured to receive user inputs or pre-populate information to build out visualization platforms, such as server name, visualization software revision, hardware model, processing capability, memory requirements, interface cards and the like. Moreover, web/presentation tier 322 may include user access sub-tier(s) to identify user access to operating systems and/or visualization/network applications.

The application tier 324 includes various sub-tiers for identifying design requirements associated with applications. In addition, the application tier 324 provides for identifying application requirements in more than one environment, such as development, production, contingency or the like. In specific embodiments, the application tier 324 includes application profile sub-tier configured to receive user inputs for environment, application product type, network type, security/firewall requirements, load balancing requirements, existing devices and the like. In addition application tier 324 may include application specification sub-tier configured to receive user inputs or pre-populate environments, server name, application product type, hardware model, processing requirements, memory requirements, storage utility status, operating system and the like. Additionally, application tier 324 may include instance specification sub-tier configured to receive user inputs or pre-populate information related to instances, such as server name, domains/cells, clusters, number of instances and the like. Moreover, application tier 324 may include user access sub-tier(s) to identify user access to operating systems.

The database tier 326 includes various sub-tiers for identifying design requirements associated with databases. In addition, the database tier 326 provides for identifying application requirements in more than one environment, such as development, production, contingency or the like. In specific embodiments, the database tier 326 includes database profile sub-tier configured to receive user inputs for environment, database product type, security/firewall requirements, optional component requirements, existing devices, contingency mechanism information, such as replication and redundancy and the like. In addition database tier 326 may include database specification sub-tier configured to receive user inputs or pre-populate environments, server name, database product type, hardware model, processing requirements, memory requirements, storage utility status, operating system and the like. Additionally, database tier 326 may include database instance sub-tier configured to receive user inputs or pre-populate information related to instances, such as server name, database server product, database instance name, current and future database size, new or existing database instance and the like. Moreover, database tier 326 may include user access sub-tier(s) to identify user access to operating systems.

The integration tier 328 includes various sub-tiers for identifying design requirements associated with integration, such as messaging, business-to-business transactions/communication and the like. In addition, the integration tier 328 provides for identifying application requirements in more than one environment, such as development, production, contingency or the like. In specific embodiments, integration tier 328 includes service oriented architecture sub-tier configured to receive user inputs for Object Orchestration Services (OOS)/webMethods/data power, interface bus, communication hub and the like. Additionally, the integration tier 328 may include integration profile sub-tier configured to receive user inputs or pre-populate environment, integration product type, network type, security/firewall requirements, clustering requirements, load balancing requirements, existing devices and the like. In addition integration tier 328 may include platform specification sub-tier configured to receive user inputs or pre-populate environments, server name, integration product type, hardware model, processing requirements, memory requirements, storage utility status, operating system and the like. Additionally, integration tier 328 may include messaging queue usage sub-tier configured to receive user inputs or pre-populate, for different messaging services, environment, message queue usage, payload size, latency queue manager/name, and the like. Moreover, integration tier 328 may include user access sub-tier(s) to identify user access to operating systems.

The other tier 329 includes various sub-tiers for identifying design requirements associated with reporting, document management and the like. In addition, the other tier 329 provides for identifying application requirements in more than one environment, such as development, production, contingency or the like. In specific embodiments, other tier 329 may include profile sub-tier configured to receive user inputs for environment, network type, security/firewall requirements, clustering requirements, load balancing requirements, existing devices and the like. In addition other tier 329 may include platform specification sub-tier configured to receive user inputs or pre-populate environments, server name, hardware model, processing requirements, memory requirements, storage utility status, operating system and the like. Additionally, other tier 329 may include user access sub-tier(s) to identify user access to operating systems. Moreover, other tier 329 may include document content management sub-tier and/or reporting specifications sub-tier configured to receive user inputs or pre-populate document content management fields and/or reporting specification fields.

The infrastructure design application 300 additionally includes specific design requirements section 330. The specific design requirements section 330 may include one or more specific design requirements sections, such as, but not limited to, mainframe specification section 332, hardware storage section 334, network and facilities section 336, operations and monitoring section 337, infrastructure capacity analysis section 338, and hosting and operations support 349. Each of the tiers may be configured to be collapsible within the application, such that if the technical requirements and/or the user/design team associate designates a section as not being applicable to the specified technical project, the section is collapsed or otherwise hidden.

In addition, the specific design requirements sections 330 are configured to receive repetitive pre-populated information based on inputs/pre-populations received in the design element tiers 320. Moreover, the specific design requirements sections 330 are configured such that inputted repetitive higher-level sub-section information is pre-populated into lower-level sub-sections, as a means of minimizing the amount of information that needs to be manually inputted by the user/design team associate.

Specific design requirements sections 330 include mainframe section 332 that is configured to receive user/build team associate inputs or pre-populated inputs associated with the mainframe requirements. The mainframe section 332 may include, but is not limited to, Customer Information Control System (CICS) implementation details subsection; mainframe Websphere Application Server (WAS) implementation details subsection; enterprise operating system Communications Services (CS) subsection; data server database characteristics subsection; Information Management System (IMS) database systems implementation details subsection; proprietary systems subsection; mainframe storage information subsection; mainframe batch information subsection; mainframe capacity planning subsection; mainframe messaging subsection; voice capability subsection; and the like.

Additionally, specific design requirements sections 330 may include hardware storage section 334 that is configured to receive user/design team associate inputs or pre-populated inputs associated with hardware storage requirements. The hardware storage section 334 may include, but is not limited to, external hardware storage subsection; detailed Storage Area Network (SAN) file system specifications subsection; detailed Network Attached Storage (NAS) file system specifications subsection; data replication requirements subsection; backup and recovery requirements subsection; internal hardware storage subsection; and the like.

In addition, specific design requirements sections 330 may include network and facilities section 336 that is configured to receive user/design team associate inputs or pre-populated inputs associated with network and facilities requirements. As such, the network and facilities section 336 may include, but is not limited to, facilities subsection and network subsection. The network subsection may further include a server network design category; a local data center load balancing design category; a Domain Name Service (DNS) design category; a file transfer category; a firewall category; a network architecture category; a general network overview category; an application network review and results category; and the like.

Additionally, specific design requirements section 330 may include operations and monitoring section 337 that is configured to receive user/build team associate inputs or pre-populated inputs associated with operations and monitoring. In addition, specific design requirements section 330 may include infrastructure capacity analysis section 338 that is configured to receive user/build team associate inputs associated with infrastructure capacity. The infrastructure capacity analysis section 338 may include, but is not limited to, transaction volume subsection; distributed capacity and performance management subsection and the like. Moreover, specific design requirements sections 330 may include hosting and operations support section 339 that is configured to receive user/build team associate inputs related to hosting and operations support.

Additionally, the infrastructure design module 130 may optionally include automated build team notification application 340 that is configured to automatically generate and communicate a build team notification to predetermined build team contacts based on the occurrence of a predetermined event. The predetermined event that triggers the automatic generation and initiation of communication of the notification may be user engagement of an electronic communication mechanism within the module 130 or completion of one or more portions of the infrastructure design application 130. For example, in specific embodiments, emails, or some other form of electronic communication, may be automatically generated upon user activation of a build team communication mechanism, such as a button or the like or completion of all, or a portion of, the infrastructure design application 300 and, once generated, communicated to the predetermined build team associates. The emails, which may serve as build team work orders, may be configured to include a link to the applicable design element tiers 320, specific design requirement sections 330 or other portions of the infrastructure design application 300 that are pertinent to that particular build team.

In addition, the infrastructure design module 130 may optionally include automated build team report application 350 that is configured to allow build teams to identify which tiers, sub-tiers, sections, sub-sections or specific information within a tier or section are relevant to the build team and, based on the customization of the build teams, generate customized build team reports that include the identified information. Such customized reports serve to provide the build team with build team-specific information that can readily be analyzed by the corresponding build team.

Thus, as described herein, present embodiments provide for methods, systems, and computer program products that provide for managing a technical project and specifically the infrastructure design of the technical project. In particular, embodiments of the invention provide for an end-to-end project delivery tool that includes designing the infrastructure of the technical project. The technical project management delivery tool herein described automates the capture of data and other functionality, such as identification of infrastructure design requirements and the like, to add increased efficiency as it relates to the design phase of a technical project. In addition, the project management delivery tool herein described improves hand-offs and communication amongst different disparate entities of a technical project.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for technical project management, the method comprising:
receiving, via a technical requirements application, first user inputs that define a plurality of high-level design elements and design requirements for a technical project;
storing, in a technical project database, the high-level design elements and design requirements;
automatically, pre-populating, via a computing device processor, first predefined input fields within an infrastructure design application with the high-level design elements and requirements; and
automatically, presenting, via a computing device processor, design element tiers and design requirement sections within the infrastructure design application that correspond to the design elements and design requirements.

2. The method of claim 1, further comprising receiving, via the infrastructure design application, second user inputs at a first design element tier that define specific infrastructure design element criteria.

3. The method of claim 2, further comprising automatically, pre-populating, via a computing device processor, second predefined input fields within the first design element tier, wherein the second predefined input fields are pre-populated with the specific infrastructure design element criteria.

4. The method of claim 2, further comprising automatically, pre-populating, via a computing device processor, third predefined input fields within one or more design requirement sections, wherein the third predefined input fields are pre-populated with the specific infrastructure design element criteria.

5. The method of claim 1, further comprising receiving, via the infrastructure design application, second user inputs at a first design requirement section that define specific infrastructure design requirement criteria.

6. The method of claim 5, further comprising automatically, pre-populating, via a computing device processor, second predefined input fields within the first design requirement section, wherein the second predefined input fields are pre-populated with the specific infrastructure design requirement criteria.

7. The method of claim 1, further comprising automatically, pre-populating, via a computing device processor, second predefined input fields with the infrastructure design application, wherein the second predefined input fields are pre-populated with project contact information.

8. The method of claim 1, further comprising automatically generating and initiating electronic communication, via a computing device processor, of an infrastructure design notification to predetermined build team contacts based on completion of one or more portions of the infrastructure design application.

9. The method of claim 8, wherein automatically generating further comprises automatically generating, via the computing device processor, the infrastructure design notification, wherein the infrastructure design notification includes a link to an output of the infrastructure design application.

10. The method of claim 1, further comprising receiving, at a computing device, second user inputs that define infrastructure design reporting criteria.

11. The method of claim 10, further comprising generating and initiating electronic communication, via computing device processor, of an infrastructure design report to predetermined build team contacts based on completion of one or more portions of the infrastructure design application, wherein the infrastructure design report includes information specified by the infrastructure design reporting criteria.

12. The method of claim 1, further comprising automatically presenting, via a computing device processor, access to one or more design infrastructure diagrams in the infrastructure design application, wherein the design infrastructure diagrams are associated with a previous related technical project.

13. The method of claim 1, further comprising automatically presenting, via a computing device processor, access to one or more design infrastructure diagrams in the infrastructure design application, wherein the design infrastructure diagrams are associated with the technical project.

14. A system for technical project management, the system comprising:
at least one computing device including at least one processor and a memory; and
a technical project management system stored in the memory and executable by the at least one processor, wherein the technical project management system includes,
a project database configured to store technical project records,
a technical requirement module including a technical requirements application configured to receive first user inputs that define a plurality of high-level design elements and design requirements for a technical project and configured to store the high-level design elements and design requirements in the project database, and
an infrastructure design module including an infrastructure design application configured to automatically pre-populate first predefined input fields n with the high-level design elements and requirements and automatically, present design element tiers and design requirement sections that correspond to the design elements and design requirements.

15. The system of claim 14, wherein the infrastructure design application is further configured to receive second user inputs at a first design element tier that define specific infrastructure design element criteria.

16. The system of claim 15, wherein the infrastructure design application is further configured to automatically, pre-populate second predefined input fields within the first design element tier, wherein the second predefined input fields are pre-populated with the specific infrastructure design element criteria.

17. The system of claim 15, wherein the infrastructure design application is further configured to automatically, pre-populate third predefined input fields within one or more design requirement sections, wherein the third predefined input fields are pre-populated with the specific infrastructure design element criteria.

18. The system of claim 14, wherein the infrastructure design application is further configured to receive second user inputs at a first design requirement section that define specific infrastructure design requirement criteria.

19. The system of claim 18, wherein the infrastructure design application is further configured to automatically, pre-populate second predefined input fields within the first design requirement section, wherein the second predefined input fields are pre-populated with the specific infrastructure design requirement criteria.

20. The system of claim 14, wherein the infrastructure design application is further configured to automatically, pre-populate second predefined input fields, wherein the second predefined input fields are pre-populated with project contact information stored in the project database.

21. The system of claim 14, wherein the infrastructure design module further comprises a build team notification application configured to automatically generate and initiate electronic communication of an infrastructure design notification to predetermined build team contacts based on completion of one or more portions of the infrastructure design application.

22. The system of claim 21, wherein the build team notification application is further configured to automatically generate the infrastructure design notification, wherein the infrastructure design notification includes a link to an output of the infrastructure design application.

23. The system of claim 14, wherein the infrastructure design module further comprises a build team reporting application configured to receive second user inputs that define infrastructure design reporting criteria.

24. The system of claim 23, wherein the build team reporting application is further configured to generate and initiate electronic communication of an infrastructure design report to predetermined build team contacts based on completion of one or more portions of the infrastructure design application, wherein the infrastructure design report includes information specified by the infrastructure design reporting criteria.

25. The system of claim 14, wherein the infrastructure design application is further configured to automatically present access to one or more design infrastructure diagrams in the infrastructure design application, wherein the design infrastructure diagrams are associated with one of the current project or a previous related technical project.

26. A computer program product comprising:
a non-transitory computer-readable medium comprising:
a first set of codes for causing a computer to receive, via a technical requirements application, first user inputs that define a plurality of high-level design elements and design requirements for a technical project;
a second set of codes for causing a computer to store, in a technical project database, the high-level design elements and design requirements;
a third set of codes for causing a computer to automatically, pre-populate, first predefined input fields within an infrastructure design application with the high-level design elements and requirements; and
a fourth set of codes for causing a computer to automatically, present design element tiers and design requirement sections within the infrastructure design application that correspond to the design elements and design requirements.

27. The computer program product of claim 26, further comprising a fifth set of codes for causing a computer to receive, via the infrastructure design application, second user inputs at a first design element tier within the infrastructure design application, wherein the second user inputs define specific infrastructure design element criteria.

28. The computer program product of claim 27, further comprising a sixth set of codes for causing a computer to automatically, pre-populate second predefined input fields within the first design element tier, wherein the second predefined input fields are pre-populated with the specific infrastructure design element criteria.

29. The computer program product of claim 27, further comprising a sixth set of codes for causing a computer to automatically, pre-populate third predefined input fields within one or more design requirement sections, wherein the third predefined input fields are pre-populated with the specific infrastructure design element criteria.

30. The computer program product of claim 26, further comprising a fifth set of codes for causing a computer to receive second user inputs at a first design requirement section within the infrastructure design application, wherein the second user inputs define specific infrastructure design requirement criteria.

31. The computer program product of claim 30, further comprising a sixth set of codes for causing a computer to automatically pre-populate second predefined input fields within the first design requirement section, wherein the second predefined input fields are pre-populated with the specific infrastructure design requirement criteria.

32. The computer program product of claim 26, further comprising a fifth set of codes for causing a computer to automatically pre-populate second predefined input fields with the infrastructure design application, wherein the second predefined input fields are pre-populated with project contact information.

33. The computer program product of claim 26, further comprising a fifth set of codes for causing a computer to automatically generate and initiate electronic communication of an infrastructure design notification to predetermined build team contacts based on completion of one or more portions of the infrastructure design application.

34. The computer program product of claim 33, wherein the fifth set of codes is further configured to cause the computer to automatically generate the infrastructure design notification, wherein the infrastructure design notification includes a link to an output of the infrastructure design application.

35. The computer program product of claim 26, further comprising a fifth set of codes for causing a computer to receive second user inputs that define infrastructure design reporting criteria.

36. The computer program product of claim 35, further comprising a sixth set of codes for causing a computer to generate and initiate electronic communication of an infrastructure design report to predetermined build team contacts based on completion of one or more portions of the infrastructure design application, wherein the infrastructure design report includes information specified by the infrastructure design reporting criteria.

37. The computer program product of claim 26, further comprising a fifth set of codes for causing a computer to automatically present access to one or more design infrastructure diagrams in the infrastructure design application, wherein the design infrastructure diagrams are associated with a previous related technical project.

38. The computer program product of claim 26, further comprising a fifth set of codes for causing a computer to automatically present access to one or more design infrastructure diagrams in the infrastructure design application, wherein the design infrastructure diagrams are associated with the technical project.
